(19) United States
(12) Patent Application Publication
(10) Pub. No.: US 2015/0006547 A1
(43) Pub. Date: Jan. 1, 2015

(54) DYNAMIC RESEARCH PANEL

(71) Applicant: 1WORLD ONLINE, INC., SAN JOSE, CA (US)

(72) Inventor: August E. GRANT, Columbia, SC (US)

(21) Appl. No.: 14/319,033

(22) Filed: Jun. 30, 2014

Related U.S. Application Data
(60) Provisional application No. 61/841,118, filed on Jun. 28, 2013.

(51) Int. Cl. G06F 17/30

(52) U.S. Cl. CPC G06F 17/30595
USPC 707/748

(57) ABSTRACT

A technique and algorithm for extracting a representative sample from a large, unrepresentative data set through the application of dynamic weighting and random assignment. The algorithm allows for the simple selection of individuals that, as a group, will closely fit any desired ratio of salient variables. The randomization algorithm allows multiple representative groups to be extracted from the same large, unrepresentative data set.

### CROSS-REFERENCE TO RELATED APPLICATIONS

This application claims priority to U.S. Provisional Application No. 61/841,118, filed Jun. 28, 2013, which is incorporated by reference as though fully included herein.

### TECHNICAL FIELD

This application relates generally to online polling, and more specifically to constructing random samples of results from polling data, enabling external validity in the resulting dataset.

### BACKGROUND OF THE INVENTION

Within Internet and online venues and digital properties, what are known to many as Web 2.0 and Big Data services, we are now transitioning to a new level of understanding that information built and shared via social and professional networks needs to be more credible and representative in order to be useful. In particular, there is unmet demand to obtain accurate, quantifiable and comprehensive data on what people really think about various topics in their life and issues in their world. As an example, to optimally plan development and sales for any product or service it is imperative for merchandisers and marketers to best understand customers' views on product features, service appeal, trends, pricing, as well as have reliable, measurable insight into consumer interests and their decision-making processes. The same is true for analysts in every other area of human life, including politics, culture, sports, entertainment, estimates of geographical, educational and vocational trends, etc.

The use of random samples in survey research is being replaced by convenience samples of respondents, with a substantial percentage of respondents volunteering or self-selecting themselves into the subject pool. Self-selected respondents are usually not representative of the underlying population, preventing application of inferential statistics to project parameters from the sample to the population. Currently, these data are presented either without modification or with weighting, assigning a relative, mathematical weight to each subject to increase the representation of underrepresented groups and to decrease the representation of overrepresented groups.

Weighting is considered an acceptable technique for generating more representative results from a data set that is skewed. But there are two problems with this technique. First, in order to add information to the dataset (providing longitudinal observations instead of cross-sectional observations), all members of the initial sample must be surveyed again, usually at a significant cost per respondent. Second, the weights create problems with applying the results to project individual behavior since overrepresented cases are counted as only a fraction of a person in the dataset, while underrepresented cases count as more than a single individual.

### SUMMARY OF THE INVENTION

The present invention relates to a method and system to extract a statistically representative sub-sample from a set of unrepresentative responses to a survey or poll. This goal is accomplished by applying an algorithm (the “DRP algorithm”) to provide a systematic and purposive selection of responses.

In one embodiment, the techniques may be realized as a method comprising the steps of receiving data for a sample of cases, the cases including at least one variable, each of the cases in the sample of cases having a marker for each of the at least one variable; assigning a weight to each of the cases in the set of cases based on the frequencies among the set of cases for each of the markers of that case, the weight further based on a desired panel frequency for each of the markers; and randomly selecting a subset of cases from the set of cases, wherein the random selection is weighted according to the assigned weights of the users such that, for each of the markers, a frequency of the marker in the selected subset approximates the desired panel frequency for that marker.

In accordance with other aspects of this embodiment, the marker may be a demographic variable, and the desired panel frequency is a known frequency in a population for the demographic variable.

In accordance with other aspects of this embodiment, the method may further include analyzing data associated with the selected subset based on the selected subset having markers with frequencies approximating the desired panel frequencies.

In accordance with other aspects of this embodiment, randomly selecting a subset of cases may include assigning a random variable to each of the cases, dividing the assigned weight of each case by the case's assigned random variable to generate a selection threshold, and selecting the cases with the highest selection thresholds.

In accordance with other aspects of this embodiment, the random selection may be weighted according to the assigned weights of the users such that, for each of the markers, a frequency of the marker in the selected subset approximates the desired panel frequency for that marker.

In accordance with other aspects of this embodiment, the method may further include displaying data from the subset as a representative sample of the data.

In accordance with another embodiment, the techniques may be realized as an article of manufacture including at least one processor readable storage medium and instructions stored on the at least one medium. The instructions may be configured to be readable from the at least one medium by at least one processor and thereby cause the at least one processor to operate so as to carry out any and all of the steps in the above-described method.

In accordance with another embodiment, the techniques may be realized as a system comprising one or more processors communicatively coupled to a network; wherein the one or more processors are configured to carry out any and all of the steps described with respect to any of the above embodiments.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

Better understanding of the present invention may be obtained by reference to the accompanying drawings, when considered in conjunction with the subsequent, detailed description.

FIG. 1 is a flow chart illustrating a method for generating a representative sample in accordance with the present invention.

FIG. 2A show data for an exemplary sample with one Marker in accordance with the present invention.

FIG. 2B is a Selection List including a selected Panel from the exemplary sample of FIG. 2A in accordance with the present invention.

FIGS. 3A and 3B show data for an exemplary sample with two Markers in accordance with the present invention.

FIG. 3C shows a selected Panel from the exemplary sample of FIGS. 3A and 3B in accordance with the present invention.

FIG. 4A shows data for an exemplary sample with three Markers in accordance with the present invention.

FIG. 4B shows a first selected Panel from the exemplary sample of FIG. 4A in accordance with the present invention.

FIG. 4C shows data from the first selected Panel from the exemplary sample of FIG. 4A in accordance with the present invention.

FIG. 4D shows data from a second selected Panel from the exemplary sample of FIG. 4A in accordance with the present invention.

FIG. 4E shows data from a third selected Panel from the exemplary sample of FIG. 4A in accordance with the present invention.

### DETAILED DESCRIPTION

The present invention relates to a method and system to extract a statistically representative sub-sample from a set of unrepresentative responses to a survey or poll. The method uses an algorithm that selects a sub-sample of a large dataset, creating a subset of users that are representative of the population being studied. The algorithm created for this invention is a new and unique method of analyzing large datasets.

This invention provides an algorithm that generates one or more representative sub-samples from an unrepresentative dataset. This invention covers the algorithm used in the selection process as well as the multi-step process of generating what we are calling the Dynamic Research Panel.

The term “Dynamic” is used because the algorithm can be run an unlimited number of times to create new sub-samples from the Initial Sample, allowing multiple follow-up opportunities with different subjects, and allowing comparison of sub-samples to each other to measure degree of representativeness.

This invention solves two problems related to large, unrepresentative datasets. First, it generates a sub-sample of the dataset this is more representative of the underlying population than the initial dataset. Second, it reduces the cost of doing follow-up research by identifying a representative sub-sample of the initial sample. Since the primary cost of survey research is the cost of administering the survey and compensating respondents, reducing the number of cases needed for follow-up substantially reduces the cost of doing follow-up research and can provide faster and more affordable research results.

The invention also allows application of statistical analysis techniques that require random samples to the analysis of large datasets by defining and extracting a representative sub-sample of the large dataset using a combination of random assignment and weighting.

The term “Dynamic” is used because the algorithm can be run an unlimited number of times to create new sub-samples from the Initial Sample, allowing multiple follow-up opportunities with different subjects, and allowing comparison of sub-samples to each other to measure the degree of representativeness. The procedure for creating new Dynamic Research Panels is identical to the initial sequence, with the only change being the generation of new “Random Seeds” for each case. These terms used in this algorithm are described below.

In some embodiments “Marker” may be understood to be a single variable with a known distribution across a population. One of ordinary skill will recognize that a large variety of different variables can be used with respect to surveyed individuals. For purposes of example, and not intending to be limited to those listed, variables may include demographic, geographic, psychographic, and behavioral variables, as well as others.

Demographic variables may include, for example, age, sex, income, education, marital status, political affiliation, number in household, number of children, religious affiliation, or employment status. Geographic variables may include, for example, postal code, city, county, state, region, country, local access transport area (LATA), or development level (urban, suburban, or rural). Psychographic variables may include, for example, personality, lifestyle, social class, activities and interests (fitness, hobbies, shopping, reading, etc.), opinions (politics, economics, social issues, etc.), and attitudes or values (health, safety, security, self-respect, warm relationships with others, sense of accomplishment, self-fulfillment, being well-respected, sense of belonging, fun-enjoyment-excitement, etc.). Behavioral variables may include, for example, purchasing behavior, commuting distance, or media consumption (television, radio, Internet, newspaper, social media, magazine, etc.). Other variables may include, for example, intelligence, grade point average, college major, or job category. Many other variables are known in the art.

In some embodiments “Random Seed” may be understood to be to a pseudo random number between 0 and 1 assigned by a computer. It is presumed that each “Random Seed” that is produced will have approximately equal chance of being anywhere on the line between 0 and 1 (that is, the distribution of numbers between 0 and 1 should be approximately flat).

In some embodiments “Initial Sample Size” may be understood to be to the number of cases in the dataset from which the Dynamic Research Panel is derived. It will be understood that, in some cases the Initial Sample Size may not represent the entirety of the captured data. For example, in some implementations where the population of available data is too large to carry out the algorithm on every subject, a random sample may be selected from a greater population of data in order to form the initial sample. In other implementations, the initial sample may be the whole population of surveyed subjects. In any case, whichever set of data represents the data from which subjects will be randomly pulled in order to form the DRP is the initial sample, and the “Initial Sample Size” is however many members there are in this group.

In some embodiments, “Designated Sample Size” (DSS) may be understood to be a parameter identified by the user that is less than the value of the “Initial Sample Size.” The DSS is the size of the resulting panel when the DRP algorithm is carried out.

It should be recognized that in order to result in a properly representative sample when using the DRP algorithm, there is a maximum size for the DSS. In addition to needing to be less than the Initial Sample Size, the maximum size of the DSS is when any particular subgroup within the population would have to have all of its members from the population present in the panel in order to achieve the desired percentage in the panel. For example, if a group is to make up 10% of a panel and there are 20 members of that group in the initial sample, then the DSS cannot be significantly larger than 200. If the panel includes significantly more than 200 subjects, it is still not possible to select more than 20 from that particular group, and so that group will soon fall below 10% of the panel.

In some embodiments “Selection List” may be understood to be an ordered list of cases from the initial data set from which the first N cases comprise the Dynamic Research Panel. The purpose of the DRP algorithm is to create a Selection List that accurately represents the desired Marker concentrations.

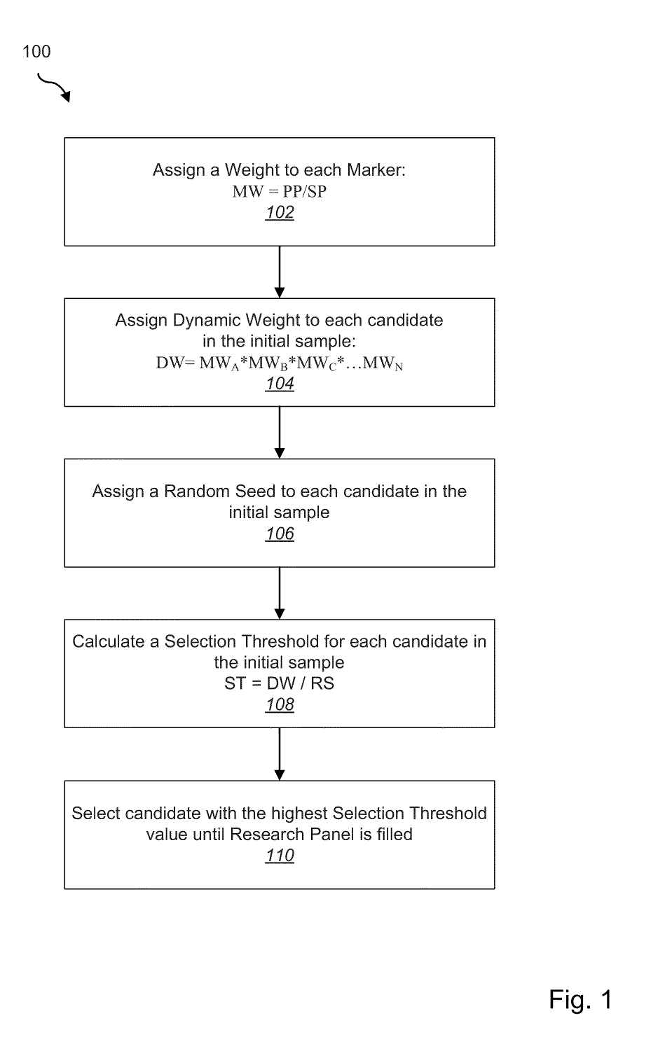

The Dynamic Research Panel is created in a multi-step process 100, as illustrated in FIG. 1. The initial step in the analysis is obtaining a large dataset that may or may not be representative of the population the dataset is created to represent. A set of variables with known distributions, hereinafter called “markers,” is defined, and the relative proportions in the population and sample are used to create a Weight for each Marker using the following formula:

MW (Marker Weight)=PP/SP
Where PP is the target proportion of the Marker in the resulting Panel, and SP is the proportion of the Marker in the Initial Sample.

For example, if our initial sample has 30 percent college graduates, and we want a panel with 20 percent college graduates, then our Marker Weight for college graduates would be MW=0.2 /0.3, or 0.67. Each value for each variable should be assigned a Marker Weight (step 102).

Once each Marker has an assigned Marker Weight, each particular case in the Initial Sample is assigned a Dynamic Weight based on the Weights of each of the Markers associated with that case (step 104). The Dynamic Weight is the product of each of the Marker Weights:

DW (Dynamic Weight)=MW_{A}*MW_{B}*MW_{C}* . . . MW_{N}
Where MW_{X} is the weight assigned to Marker X; N is the number of different Markers that apply to a particular case

For example, if “Caucasian” has a Marker Weight of 0.5 and “college graduate” has a Marker Weight of 0.67 with race and education as the only two variables, then a case within the Initial sample that is a Caucasian college graduate will have a Dynamic Weight of 0.5*0.67=0.33.

In addition to assigning each of the cases in the Initial Sample a Dynamic Weight based on the case's Markers, each case is also assigned a Random Seed (step 106). The values of the Random Seeds should each be randomly selected from an even distribution of between 0 and 1 as described above; the value of the Random Seeds should not depend on the DW or any other value associated with the particular case.

Next, a Selection Threshold is calculated for each case (step 108). The Selection Threshold is the Dynamic Weight divided by the Random Seed. The Selection Threshold can be any positive real number. The higher a case's Selection Threshold, the sooner it is selected to be included in the Panel.

To determine which cases go on the Panel, begin by choosing the case with the highest Selection Threshold, and add that case to the Panel. Continue adding cases starting with the highest Selection Threshold among the remaining cases until the number of selected cases equals the DSS (step 110).

Another way to express this step is to sort the cases into descending order by Selection Threshold, thus creating the Selection List. The first DSS cases on the Selection List make up the Dynamic Research Panel.

The term “Dynamic” is used because the algorithm can be run an unlimited number of times to create new sub-samples from the Initial Sample, allowing multiple follow-up opportunities with different subjects, and allowing comparison of sub-samples to each other to measure the degree of representativeness.

To run the algorithm again with the same Initial Sample, generate a new set of Random Seeds for the cases, recalculate the Selection Thresholds based on the new Random Seeds and the existing DW values, and then re-sort the Selection List based on the new Selection Thresholds.

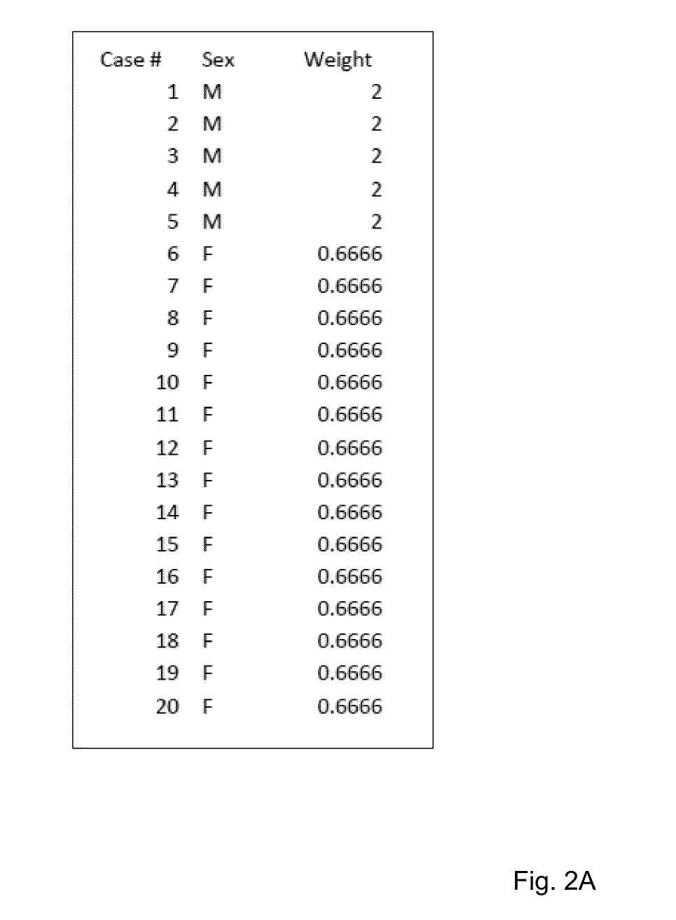

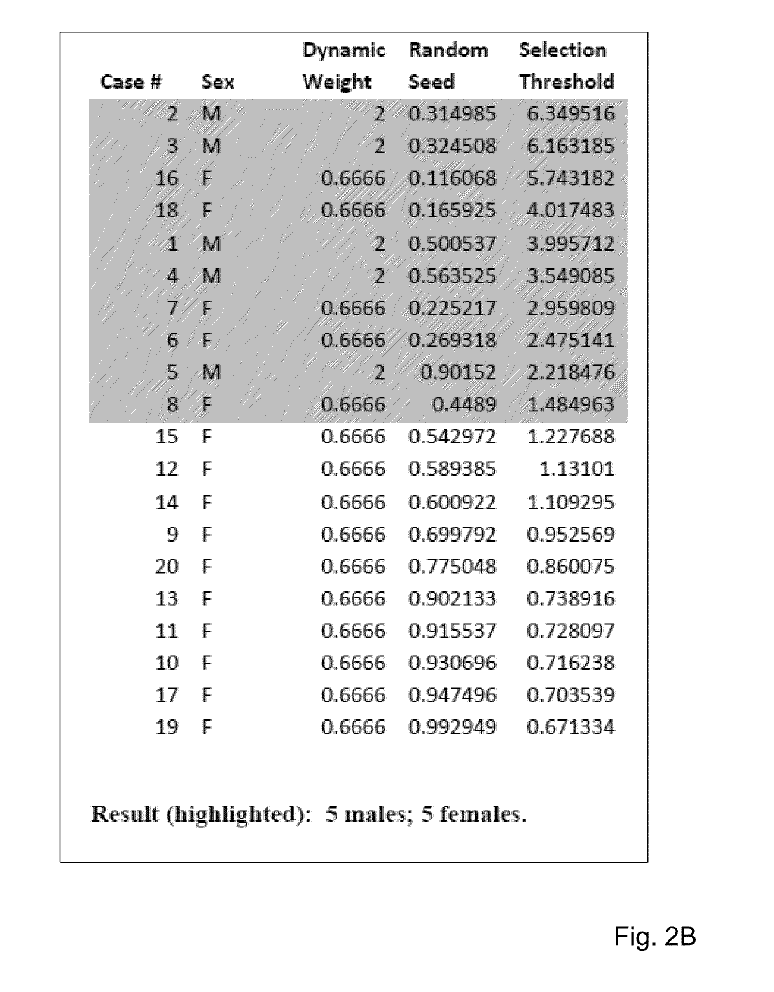

The remaining figures provide some examples of data sets sorted according to the method described herein. FIG. 2A is an exemplary data set of 20 cases in which 15 are female and 5 are male. It is desired to select a Panel of 10 cases in which half are male and half are female.

FIG. 2B shows the Selection List after each case is assigned a Random Seed and the resulting Selection Threshold is calculated. The shaded cases represent the 10 cases with the highest Selection Thresholds. The result is a Panel with 5 male Markers and 5 female Markers, as desired.

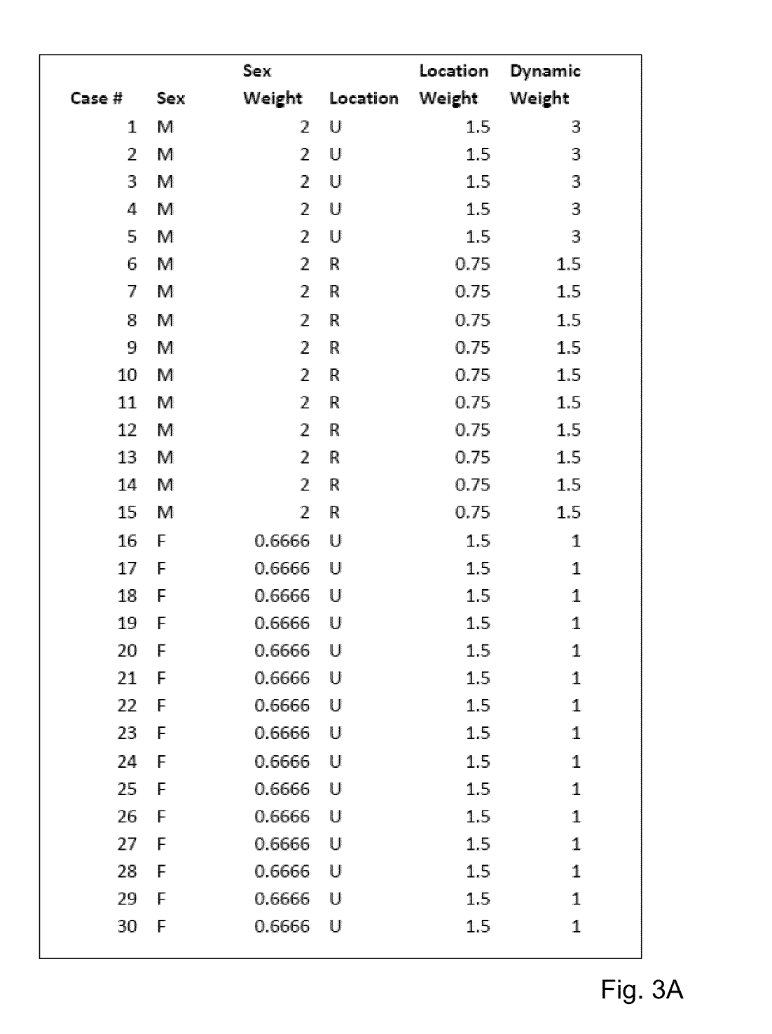

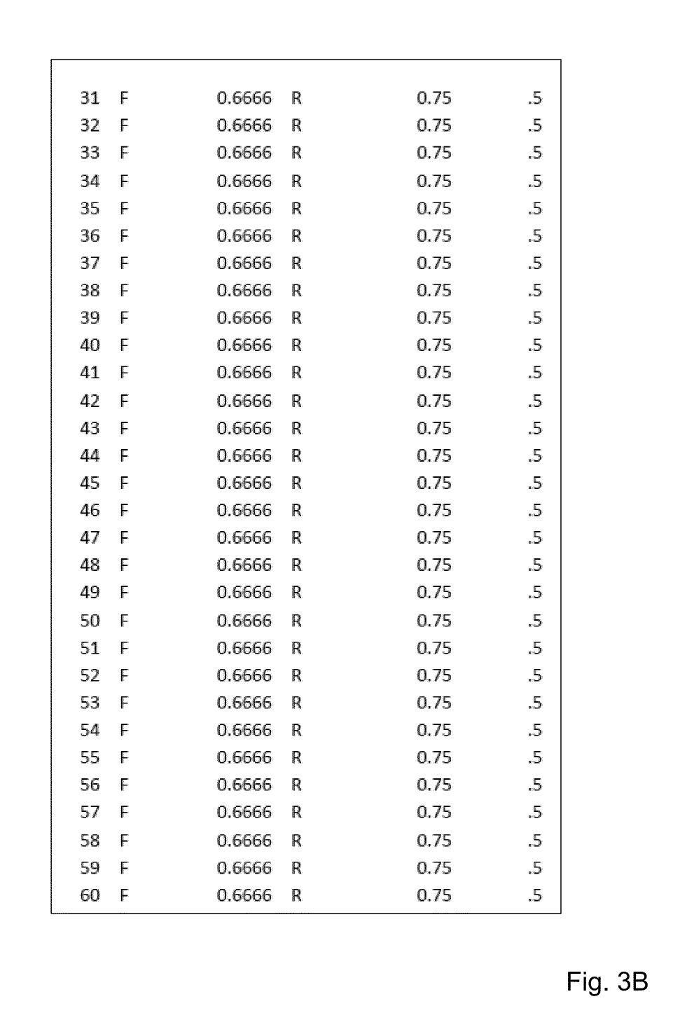

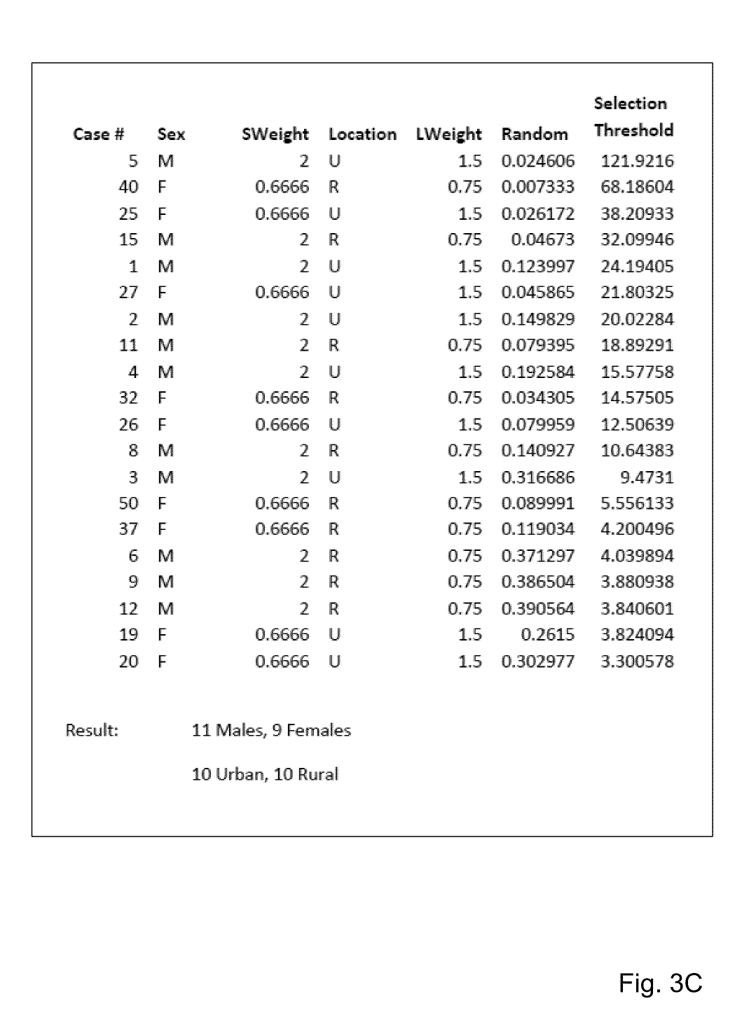

FIGS. 3A and 3B show a larger data set of 60 cases representing two variables. 25% of the cases are male and 75% female. One third of the cases are urban, two-thirds rural. The desired Panel includes 20 members and is made up of equal numbers of male and female and equal numbers of rural and urban candidates.

FIG. 3C lists only the Panel members from the application of the DRP algorithm—the twenty cases that had the largest Selection Threshold values after Random Seeds were assigned. The resulting panel has 11 males and 9 females, as well as 10 urban and 10 rural Markers. Within an expected margin of error, the selected Panel correctly represents the desired proportions of both Markers.

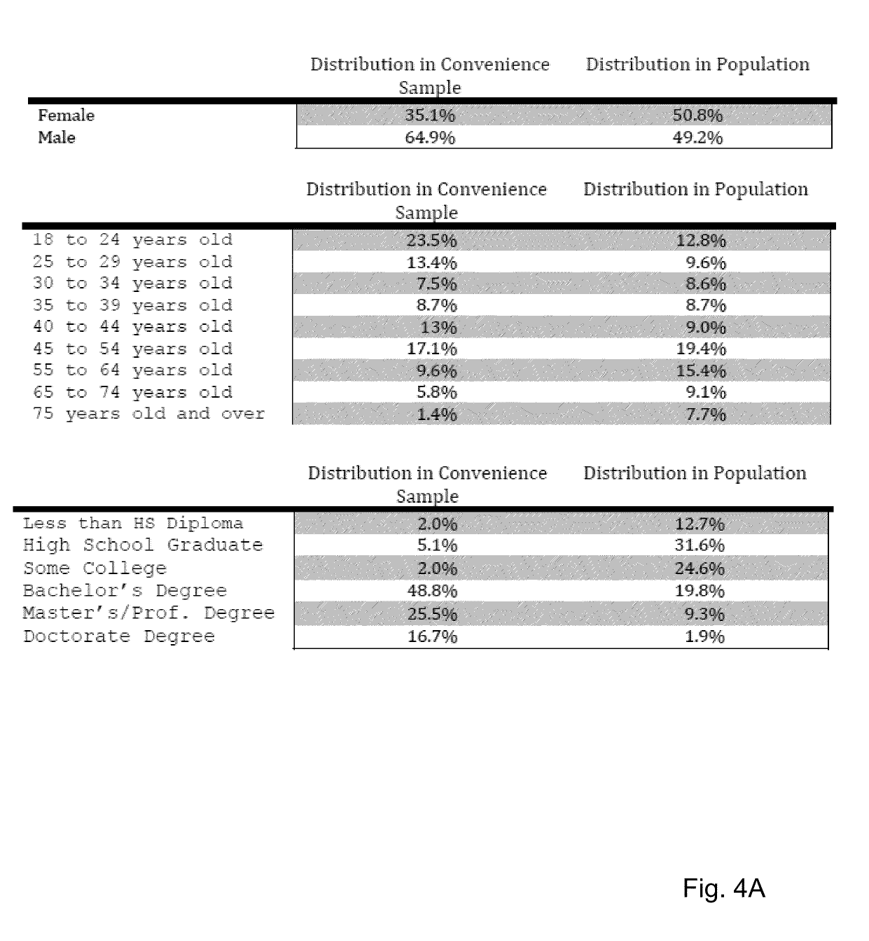

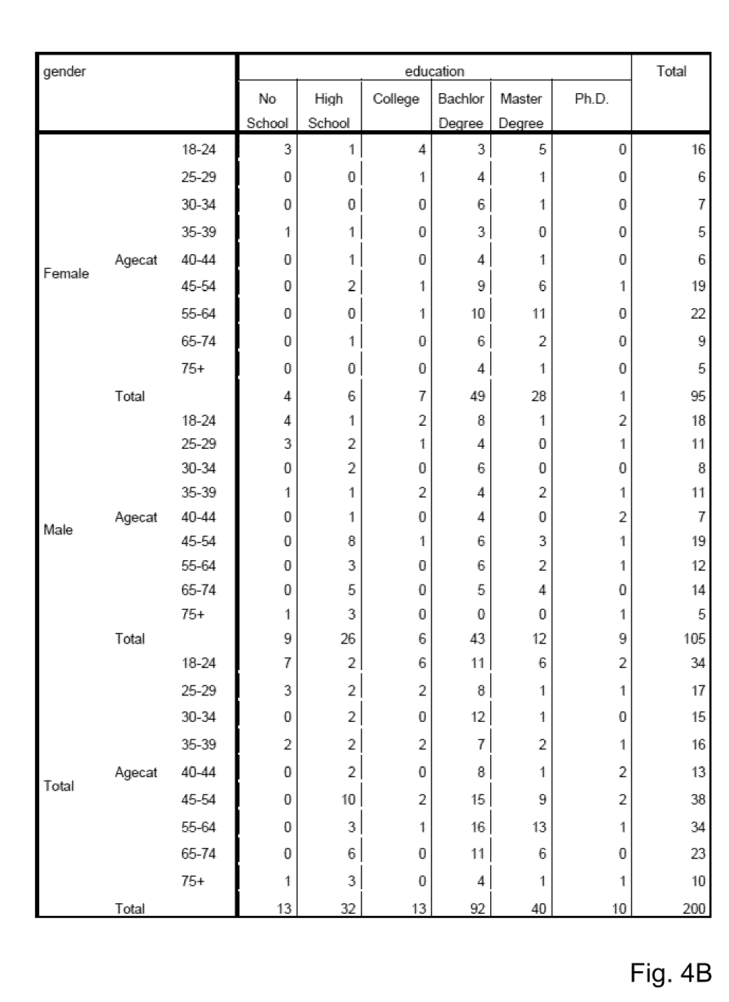

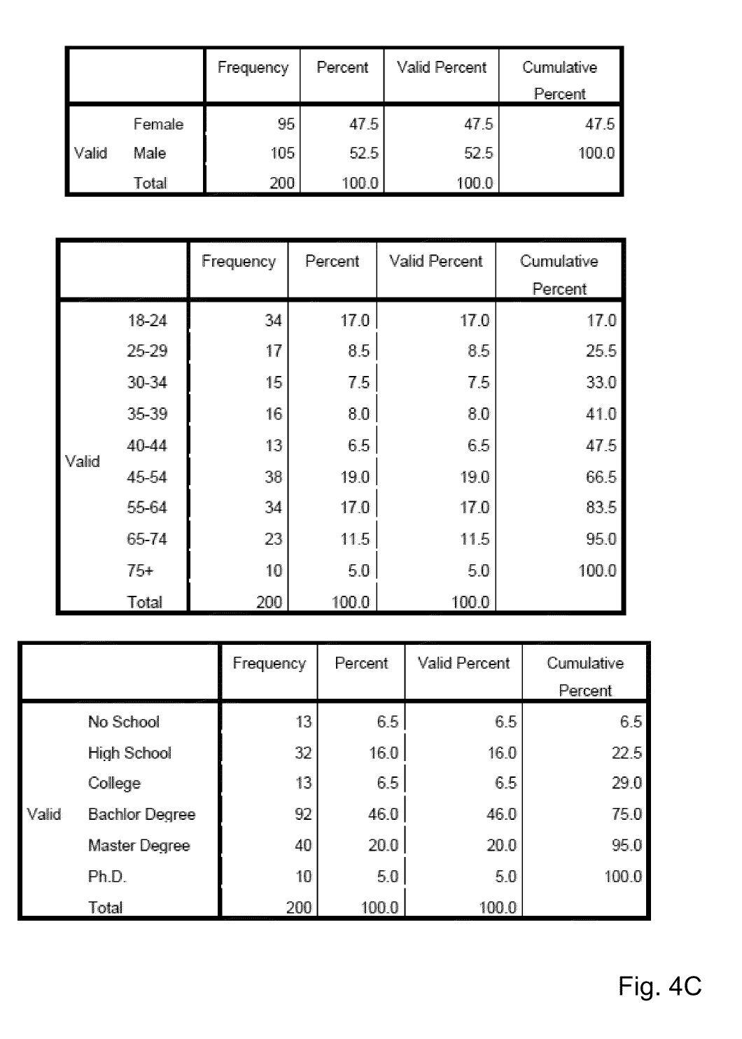

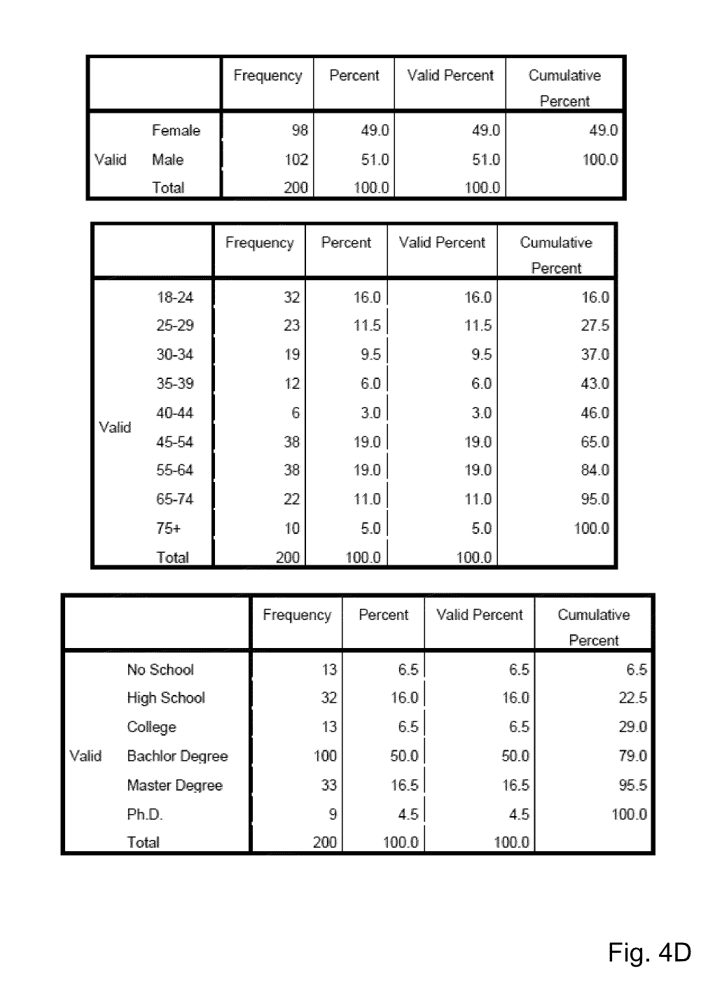

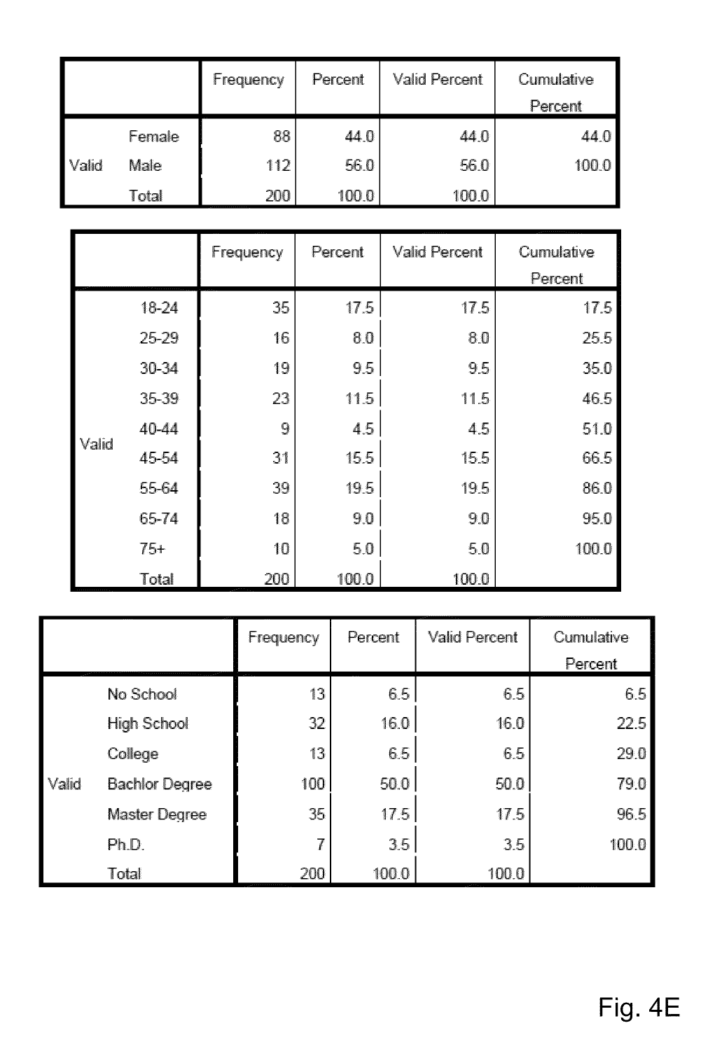

As a further example, FIG. 4A gives the proportions for three Markers for an Initial Sample of 737 cases. The accepted population distribution for these Markers is also given, which for this example forms the desired proportion for the Panel.

FIG. 4B shows a first example of the application of the DRP algorithm to select a Panel of 200 cases from the Sample of 737 cases. The resulting Panel includes, for example, 4 females with no schooling, 8 people ages 25-29 with a bachelor's degree, and 5 males over seventy-five. FIG. 4C summarizes the Markers present in the resulting Panel.

As noted above, multiple Panels can be drawn from the same Initial Sample by reassigning the Random Seeds and recalculating the Selection Threshold values. FIGS. 4D and 4E each include the Marker values for additional Panels drawn from the same Initial Sample of 737 cases.

Although the proportions of the Panels are much closer to the desired values than the initial sample, some shortcomings will be noted. For example, in none of the three generated Panels does the percentage of “no school” cases exceed 6.5 percent. This is an example of what was noted earlier in that the Panel can only draw as many cases with a certain Marker as are found in the entire Initial Sample, and there are only 13 cases with “no school” in the entire 737-case Sample. The result is that these same 13 cases are selected in all three Panels, while this particular Marker remains underrepresented relative to the population.

The logic to conduct this invention is delivered as software modules. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

At this point it should be noted that techniques in accordance with the present disclosure as described above may involve the processing of input data and the generation of output data to some extent. This input data processing and output data generation may be implemented in hardware or software. For example, specific electronic components may be employed in circuitry for implementing the functions in accordance with the present disclosure as described above. Alternatively, one or more processors operating in accordance with instructions may implement the functions in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

1. A computer-implemented method, comprising:
receiving data for a sample of cases, the cases including at least one variable, each of the cases in the sample of cases having a marker for each of the at least one variable;
assigning a weight to each of the cases in the set of cases based on the frequencies among the set of cases for each of the markers of that case, the weight further based on a desired panel frequency for each of the markers; and
randomly selecting a subset of cases from the set of cases, wherein the random selection is weighted according to the assigned weights of the users such that, for each of the markers, a frequency of the marker in the selected subset approximates the desired panel frequency for that marker.

2. The computer-implemented method of claim 1, wherein the marker is a demographic variable, and the desired panel frequency is a known frequency in a population for the demographic variable.

3. The computer-implemented method of claim 1, further comprising:
analyzing data associated with the selected subset based on the selected subset having markers with frequencies approximating the desired panel frequencies.

4. The computer-implemented method of claim 1, wherein the randomly selecting a subset of cases comprises:
assigning a random variable to each of the cases,
dividing the assigned weight of each case by the case's assigned random variable to generate a selection threshold, and
selecting the cases with the highest selection thresholds.

5. The computer-implemented method of claim 1, further comprising:
randomly selecting a second subset of cases from the set of cases, wherein the random selection is weighted according to the assigned weights of the users such that, for each of the markers, a frequency of the marker in the selected subset approximates the desired panel frequency for that marker.

6. The computer-implemented method of claim 1, further comprising:
displaying data from the subset as a representative sample of the data.

7. At least one non-transitory processor readable storage medium storing a computer program of instructions configured to be readable by at least one processor for instructing the at least one processor to execute a computer process for performing the method as recited in claim 1.

8. A system comprising:
one or more processors communicatively coupled to a network; wherein the one or more processors are configured to:
receive data for a sample of cases, the cases including at least one variable, each of the cases in the sample of cases having a marker for each of the at least one variable;
assign a weight to each of the cases in the set of cases based on the frequencies among the set of cases for each of the markers of that case, the weight further based on a desired panel frequency for each of the markers; and
randomly select a subset of cases from the set of cases, wherein the random selection is weighted according to the assigned weights of the users such that, for each of the markers, a frequency of the marker in the selected subset approximates the desired panel frequency for that marker.

9. The system of claim 8, wherein the marker is a demographic variable, and the desired panel frequency is a known frequency in a population for the demographic variable.

10. The system of claim 8, wherein the processors are further operable to analyze data associated with the selected subset based on the selected subset having markers with frequencies approximating the desired panel frequencies.

11. The system of claim 8, wherein the randomly selecting a subset of cases comprises:
assigning a random variable to each of the cases,
dividing the assigned weight of each case by the case's assigned random variable to generate a selection threshold, and
selecting the cases with the highest selection thresholds.

12. The system of claim 8, wherein the processors are further operable to randomly select a second subset of cases from the set of cases, wherein the random selection is weighted according to the assigned weights of the users such that, for each of the markers, a frequency of the marker in the selected subset approximates the desired panel frequency for that marker.

13. The system of claim 8, wherein the processors are further operable to display data from the subset as a representative sample of the data.

14. An article of manufacture comprising:
at least one processor readable storage medium; and
instructions stored on the at least one medium;
wherein the instructions are configured to be readable from the at least one medium by at least one processor and thereby cause the at least one processor to operate so as to:
receive data for a sample of cases, the cases including at least one variable, each of the cases in the sample of cases having a marker for each of the at least one variable;
assign a weight to each of the cases in the set of cases based on the frequencies among the set of cases for each of the markers of that case, the weight further based on a desired panel frequency for each of the markers; and
randomly select a subset of cases from the set of cases, wherein the random selection is weighted according to the assigned weights of the users such that, for each of the markers, a frequency of the marker in the selected subset approximates the desired panel frequency for that marker.

15. The article of claim 14, wherein the marker is a demographic variable, and the desired panel frequency is a known frequency in a population for the demographic variable.

16. The article of claim 14, wherein the instructions further cause the at least one processor to operate so as to analyze data associated with the selected subset based on the selected subset having markers with frequencies approximating the desired panel frequencies.

17. The article of claim 14, wherein the randomly selecting a subset of cases comprises:
assigning a random variable to each of the cases,
dividing the assigned weight of each case by the case's assigned random variable to generate a selection threshold, and
selecting the cases with the highest selection thresholds.

18. The article of claim 14, wherein the instructions further cause the at least one processor to operate so as to randomly select a second subset of cases from the set of cases, wherein the random selection is weighted according to the assigned weights of the users such that, for each of the markers, a frequency of the marker in the selected subset approximates the desired panel frequency for that marker.

19. The article of claim 14, wherein the instructions further cause the at least one processor to operate so as to display data from the subset as a representative sample of the data.
